(19) United States
(12) Patent Application Publication
(10) Pub. No.: US 2012/0022994 A1
(43) Pub. Date: Jan. 26, 2012

(54) Large Block Trading System with Trading Controls for Aggressive Pricing

(75) Inventors: Neil W. CONARY, Exeter, NH (US); Stephen R. MIELE, JR., Wellesley, MA (US)

(73) Assignee: LEVEL ATS, Boston, MA (US)

(21) Appl. No.: 13/112,188

(22) Filed: May 20, 2011

Related U.S. Application Data
(60) Provisional application No. 61/348,864, filed on May 27, 2010.
(60) Provisional application No. 61/348,864, filed on May 27, 2010.

(51) Int. Cl. G06Q 40/00

(52) U.S. Cl. 705/37

(57) ABSTRACT

A system and method for trading large blocks of securities with controls for limiting trading under conditions of aggressive pricing are described The system and method are preferably used by a buyer or seller in the electronic trading of securities in dark pools, e.g., and ATS or ECN, that include algorithmic trading or other computer-based programmed trading. Preferably, the system and method will be automatically activated to control trading volume when the price of a security being traded becomes aggressive and priced outside of the trader's target price instructions.

This application claims the benefit under 35 U.S.C. §119(e) of U.S. Provisional Patent Application No. 61/348,864 filed May 27, 2010 titled “Large Block Trading System with Trading Controls for Aggressive Pricing”, incorporated herein reference.

### FIELD OF THE INVENTION

The present invention relates to systems and methods for trading large blocks of securities. More specifically, the present invention relates to systems and methods for automatically and anonymously trading large blocks of securities, which include controls for limiting trading of a particular security when the price of that security is outside predetermined target price instructions.

### BACKGROUND OF THE INVENTION

It is commonplace for broker/dealers and institutional traders to desire to trade large blocks of securities. This provides an ability to take advantage of market realities and hopefully maximize profits for their clients. Whether the large block trader is acting as a buyer or seller, there is a strong desire to be able to trade anonymously so that his/her identity and trading intentions will not affect transaction pricing. Therefore, anonymity is important in large block trading situations because there may not be a single entity with which to transact such large block trades and it may have to be split up among a number of buying or selling counterparties.

There also is a desire for large block traders acting as buyers or sellers to effect large block trades automatically as well as anonymously. Such auto-trading will identify matching or near matching buyers and sellers in electronic market transactions. Auto-trading of this type will include preferred price ranges at which buyers and sellers will transact trades and a mechanism that will determine the exact trading or transaction price. Preferably, these actions are carried out without the counterparties to transaction knowing the other party's identity.

In recent years, the dramatic increases in the capability of computer and telecommunications technologies, changes in the organizational structure of large market systems, as well as changes in the national market structure precipitated by regulatory changes have caused the emergence and growth of a variety of electronic equity trading venues to capture order flow. As such, the barriers to entry in the financial industry are substantially lower, innovative trading facilities are able to offer traditional order matching and execution services faster and cheaper, and provide certainty of order fulfillment sooner. These trading venues consist of internalized order flow at broker/dealers, Electronic Communication Networks (“ECNs”), and Alternative Trading Systems (“ATSs”).

Many of these venues are also “Non-Displayed Markets” where buy and sell orders cross and are executed without the benefit of publicly available quotes. Non-Displayed Markets of this type are commonly referred to as “dark pools” of liquidity. Dark pools are preferred trading venues for large block trades because trading large blocks of securities on these venues will not adversely affect market price as it would if such trades were made visible on a securities exchange display book.

In many cases, the communications between a broker/dealer or institutional trader, as a buyer or seller, with a dark pool will be made using a known communications protocol. One of the preferred communications protocols is the financial information exchange (“FIX”) protocol. This protocol is adaptable for use on a variety trading venues.

Automatic and anonymous dark pool trading systems of the type briefly described above will continually collect information from buyers and sellers relating to volume and price parameters for orders and passively determined transaction prices. The systems will then execute trades based on the collected order information. In a number of cases, the price for securities may be linked to the national best bid/offer prices (“NBBO”). Further, the transaction price at which the securities are traded may be equal to or associated with the NBBO mid-point at the time of the trade, which will treat each of the transacting counterparties fairly.

Automatic and anonymous dark pool trading systems that receive and store multiple, computer-generated orders of any size, including large block size orders, may base trading activities on algorithmic or computer-based programmed trading, hereinafter referred to as “algorithmic trading.” Algorithmic trading uses a computer program for matching buy and sell orders, and the algorithm decides such things as timing, price, and quantity of the order for trading among counterparties.

Algorithmic trading programs incorporated at dark pool facility may be programmed to carry out automatic and anonymous electronic trading based on the NBBO and NBBO mid-point pricing. Trading instructions that are input by the buyer or seller to the dark pool facility from a client server, generally a personal computer, may include parameters such as quantity, target prices, time the order is to remain active, and transaction price determinatives to name a few. Automatic and anonymous trades will be carried out based on these parameters.

If transaction pricing is set to the NBBO mid-point at the time of the trade and this price becomes aggressive with respect to target price instructions provided by the buyer or seller, typically, trading will stop as to that security until the NBBO mid-point price becomes less aggressive and is again within the target price instructions. This is particularly applicable to limit and pegged orders.

In more detail regarding limit orders, the trader as a buyer will provide a upper target price instruction, for example, within the NBBO, above which trading will be blocked and as a seller a lower target price instruction, within the NBBO, below which trading will be blocked. The blocked trading condition with respect to a buyer or seller will continue until the transaction price for the security is again at or below the upper target instruction by the trader as a buyer and at or above the lower target instruction by the trader as a seller.

In more detail regarding pegged orders, which act like limit orders, the price for trading a security fluctuates relative to another value. The price of the pegged order will follow that value. Pegged orders can have target prices, and, as such, during the time that the trading price is outside target prices, the buyer or seller is blocked from effecting trades to either obtaining that security (as the buyer) or obtaining liquidity (as the seller) until the transaction price is again within the target prices.

Noting the restrictive features of limit and pegged orders relating to the times at which trading will be blocked, a buyer or seller may desire to continue to effect trades when the transaction price is outside the target prices but in a controlled manner, for example, when NBBO mid-point pricing passes outside one of the target prices. However, current systems do not permit this in a manner in which the buyer or seller has a great deal of flexibility when to reenter a normal trading mode as the aggressive pricing that caused trading stoppage lessens.

Therefore, it would be desirable to have a system and method that will control auto-trading when the transaction price for a security is outside target price instructions to increase order fulfillment for buyers and sellers, for example, in trading large blocks of securities.

### SUMMARY OF THE INVENTION

The present invention is a system and method for trading large blocks of securities with controls for limiting trading under conditions of aggressive pricing. The present invention is preferably used in the electronic trading of securities, such as in dark pools, e.g., ATSs or ECNs, that effect trading using algorithmic or other types of computer-based programmed trading.

When the present invention is implemented in dark pool facilities, a trader, as a buyer or seller, can control (1) trading transactions during normal trading and (2) in aggressive pricing situations when the transaction price for trading a security is outside the target prices associated with limit orders or pegged orders, control trading in a controlled manner. Therefore, according to the present invention, when the transaction price for trading a security becomes aggressive and is outside of the target price instructions, the trading volume will be continued but controlled until such time as the transaction price for that security becomes less aggressive to a level at which the normal trading mode will be resumed.

During the time the transaction price for trading the security is outside the target price instructions, only a certain trading volume may be effected within a predetermined time period, e.g., 5,000 shares per 30 second time period. Once this volume is reached within the predetermined time period, no additional trading volume will be permitted until expiration of the current time period and a new time period commences.

In a preferred embodiment of the present invention, a trading control facility implemented in the dark pool facility will be activated to control trading volume when the transaction price for a particular security trading at the NBBO mid-point passes through the upper target price for buyers or the lower target price for sellers. The normal trading mode will be resumed when the NBBO mid-point becomes less aggressive and passes through a value equal to the NBBO mid-point price at the time a particular order was entered into the dark pool facility. Accordingly, there is hysteresis between the price that triggered the trading control facility of the present invention and the reverse trigger price to resume the normal trading mode. Preferably, the trigger price and reverse trigger price are set by the trader through trading instructions.

An object of the present invention is to provide a system and method for the automatic and anonymous electronic trading of large blocks of securities using dark pool facilities that protect against price aggression.

Another object of the present invention is to provide a system and method for the automatic and anonymous electronic trading of large blocks of securities using dark pool facilities in which under aggressive pricing conditions the trading volume will be controlled per a predetermined time period.

A still further object of the present invention is to provide a system and method for the automatic and anonymous electronic trading of large blocks of securities using dark pool facilities incorporating algorithmic trading programming in which under aggressive pricing conditions the trading volume will be controlled per a predetermined time period.

A yet further object of the present invention is to provide a system and method for the automatic and anonymous electronic trading of large blocks of securities using dark pool facilities in which there is hysteresis between the trigger price at which the system enters a trading volume control mode and the reverse trigger price at which the system resumes a normal trading mode.

These and other objects of the invention will be described in greater detail in the remainder of the specification referring to the drawings.

### BRIEF DESCRIPTION OF THE DRAWINGS

FIG. 1 is a representative block diagram of a system that may incorporate the present invention.

FIG. 2 shows the dark pool facility of FIG. 1 in greater detail with the features of the system of the present invention prominently shown.

FIG. 3 shows a representative NBBO and representative target prices.

FIG. 4 shows a representative NBBO, dollar value trigger price, and reverse trigger price, and representative target prices.

FIG. 5 shows a representative NBBO, trigger price based on a percentage of the NBBO mid-point, and reverse trigger price, and representative target prices.

FIG. 6 shows a representative NBBO, dollar value trigger price, and reverse trigger price, and representative target prices and trading prices of a security at time periods T₁ to T_{N}.

### DETAILED DESCRIPTION OF THE INVENTION

The present invention is a system and method for automatically and anonymously trading large blocks of securities with controls for limiting trading volume under aggressive pricing conditions. The present invention is preferably used by a buyer or seller in the electronic trading of securities in dark pool facilities, e.g., an ATS or ECN, that include algorithmic trading or other computer-based programmed trading.

Preferably, the present invention is implemented in dark pool facilities in which the trader, as a buyer or seller, can control trading transactions through trading instructions relating to the price at which trading transactions may be effected. The present invention also is preferably implemented with limit orders or pegged orders when the transaction price at which that security is being traded becomes aggressive and moves outside the target prices. More specifically, the trading control facility of the present invention will be activated to control trading volume when the transaction price of a security being traded becomes aggressive and priced outside of the trader's target price instructions for limit orders or pegged orders. During this time, trading will be continued but controlled until such time as the transaction price for the security becomes less aggressive to a predetermined level at which the normal trading mode will be resumed.

Without the features of the present invention, during the time the transaction price for a particular security is outside the target prices of the trader's trading instructions, the system will block trading and therefore a trader cannot obtain liquidity as a seller or order fulfillment as a buyer. If buyers or sellers wanted to carry out order execution under these conditions, they would have to manually enter the system and selectively make trades which is inefficient and ineffectual in the current electronic trading environment and particularly with regard to the large block trading environment.

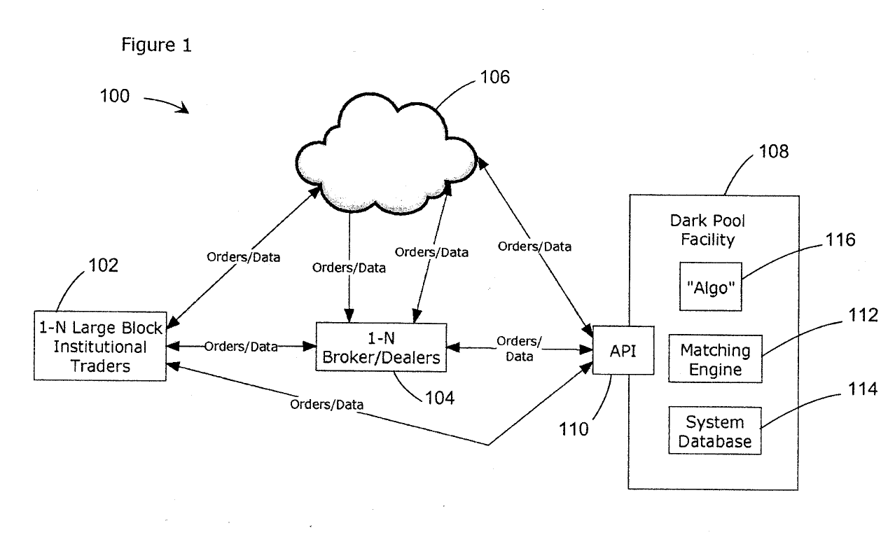

Referring to FIG. 1, generally at 100, an electronic trading system that includes a dark pool facility and may incorporate the system and method of the present invention is shown. Preferably, dark pool facility 108 includes matching engine 112 that is used for executing matches between crossing orders entered on the dark pool facility. Dark pool facility 108 also includes system database 114 for storing buy and sell orders entered onto the dark pool facility by buyers and sellers and storing trading execution information. Matching engine 112 may use algorithmic (“algo”) trading programming 116 for automatically and anonymously carrying out trading transactions, which includes large block trading transactions. Although, preferably, automatic and anonymous trading is carried out within dark pool facility 108 using algo trading programming 116, it is understood that other order execution methods, including other automatic and anonymous trading methods, may be used by dark pool facility 108 and still be within the scope of the present invention.

Dark pool facility 108 includes application programming interface (“API”) 110 to which bidirectional electronic communication links from 1-N large block institutional traders 102 and 1-N broker/dealers 104 connect. The bidirectional electronic communications links are for the transmission of orders and data from 1-N large block institutional traders 102 and 1-N broker/dealers 104 to dark pool facility 108, and the transmission of transaction data, including transaction completion data, from the dark pool facility to the 1-N large block institutional traders and 1-N broker/dealers. The communications links can be direct, hardwire connections from either the 1-N large block institutional traders or 1-N broker/dealers to the dark pool facility through API 110, or indirect, wireless connections, for example, via the Internet 106, or a combination of wired and wireless connections (hybrid). Both the direct, indirect, and hybrid communications links are within the scope of the present invention.

It is understood that 1-N institutional traders 102 may communicate orders and trading instructions directly to dark pool facility 108 or through 1-N broker/dealers 104. Both methods are within the scope of the present invention.

Dark pool facility 108 is a computer-based system that may be implemented through one or more computers and/or server computers, such as a system server. The dark pool facility may also be implemented through a single computer or distributed network of computers and still be within the scope of the present invention.

Preferably 1-N institutional traders 102 and 1-N broker/dealers 104 communicate with dark pool facility 108 with personal computers, desktop computers, workstations, main-frame computers or the like programmed for use with the dark pool facility. For example, traders may enter orders and trading instructions and receive transaction information with these or other computer-based systems at the 1-N institutional trader or 1-N broker/dealer sites.

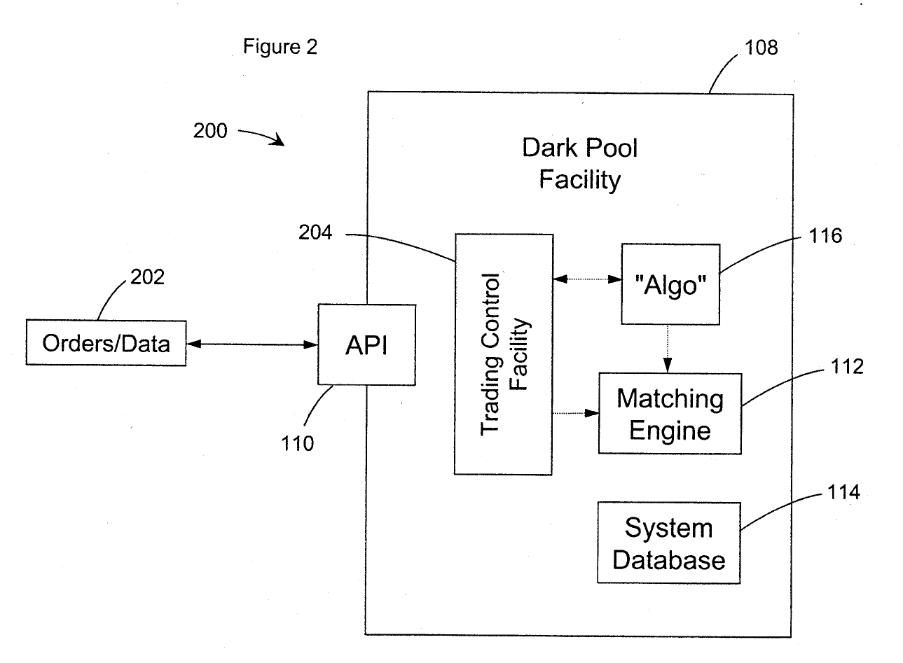

Referring to FIG. 2, generally a 200, a more detailed view of dark pool facility 108 is shown that incorporates the trading control facility of the present invention. In FIG. 2, dark pool facility 108, as stated, includes matching engine 112, system database 114, algo programming 116, and API 110. API 110 will receive buy and sell orders and data from generic electronic communications link 202 from the system clients of 1-N large block institutional traders 102 and/or 1-N broker/dealers 104, and transmits transaction related data back to them using generic electronic communications link 202.

Dark pool facility 108 also includes trading control facility 204 that connects to algo programming 116 and matching engine at 112. During the normal trading mode, preferably, algo programming 116 will control the automatic and anonymous trading activity by auto-matching counterparties using matching engine 112 and system database 114. For limit and pegged orders, algo programming 116 will carry out the normal trading mode as long as the transaction price at which a security is being traded is within the target prices specified by the trader in his/her trading instructions. However, if the transaction price of the security moves outside of the target prices, normal algorithmic trading with regard to that security is blocked until such time as the transaction price retreats to a predetermined level within the target price instructions of the trader and the normal trading mode is resumed.

It is understood there are a number of methods for pricing a security for auto-trading. For example, algorithmic trading could price trades (1) at the NBBO mid-point if there are crossing quantities of counterparties, or (2) at a mid-point between the buyer's and seller's prices as long as the transaction price is within the NBBO, or (3) at some other price determined by a computer-based program or otherwise. These and other price determining methods are considered to be within the scope of the present invention for automatic and anonymous trading using algorithmic or computer-based programmed trading methods. Whatever the method, the transaction price will be compared to the target prices provided by the trader in his/her trading instructions.

Trading control facility 204 of the present invention, which is preferably disposed in dark pool facility 108, is programming that is connected to algo programming 116 and matching engine 112. Trading control facility 204 includes as inputs at least the trader's target price instructions, trigger price instructions, and reverse trigger price instructions, and the current transaction price. The trigger price is a price at which the trading control facility will be activated to control order transaction flow when the transaction price becomes aggressive outside the target price with respect to a buyer or seller. The reverse trigger price is the price at which the trading control facility is deactivated and the normal trading mode is resumed.

It is also contemplated as a further embodiment of the present invention that dark pool facility 108 may be configured for the activation of trading controlled facility 204 when the transaction price of a security passes through the target price that applies to a buyer or seller and will remain activated up to a higher transaction price for a buyer or down to a lower transaction price for a seller but after passing either of these higher or lower prices, the system will block all further trading with regard to that security. Trading will remain totally blocked in this further embodiment until the transaction price become less aggressive and passes back through the total blocking price, respectively, for a buyer or seller, and controlled trading will be resumed.

In the preferred embodiment, once trading control facility 204 is activated, it will remain active until such time as the reverse trigger price is crossed as the transaction price for the security becomes less aggressive. According to this preferred embodiment, the reverse trigger price may be the NBBO mid-point at the time the order was entered onto the dark pool facility. For example, if at the time an order was entered onto dark pool facility 108 the NBBO is $9.00-$9.20, the NBBO mid-point would be $9.10. The trigger price could be set by the trading instructions at $9.18 and the reverse trigger price would be $9.10.

As shown, the reverse trigger price is independent of the trigger price. Therefore, according to the present invention, there is a delta or hysteresis between the trigger price that activates the trading control facility and the reverse trigger price that deactivates this facility.

When trading control facility 204 is activated, only a predetermined trading volume may be effected within a predetermined time period provided by the trader in trading instructions or as a default condition of the trading control facility. This trading volume limit will apply to each predetermined time as long as trading control facility 204 is activated. Preferably, if the trading volume limit is not reached during any particular time period, the excess is not applied to the succeeding time period. For example, if during time period T₁, the transaction volume was 9,000 shares and the volume limit per time period was 10,000 shares, the remaining 1,000 shares would not be added to time period T₂ so that the transaction volume limit for time period T₂ would be 11,000 shares. However, it is understood that the system of the present invention may be configured to roll over the excess to the next time and still be within the scope of the present invention as will be explained subsequently.

The present invention may be implemented for the benefit of either buyers or sellers of securities. For example, a buyer may automatically activate trading controlled facility 204 when the price of a security becomes aggressive and passes through the upper target price of his/her target prices. With regard to a seller, a seller may automatically activate trading control facility 204 when the price becomes aggressive and passes through the lower target of his/her target prices. In both cases, the trading control facility may be deactivated, for example, when the transaction price becomes less aggressive and passes through the reverse trigger price, which may be the NBBO mid-point at the time the order was entered onto the dark pool facility, in the appropriate direction for the buyer or seller. It is understood, however, that the buyer or seller may deactivate trading control facility 204 at other than the NBBO mid-point and still be within the scope of the present invention.

The buyer's or seller's selection of the reverse trigger price, which deactivates trading control facility 204, will determine how quickly the buyer or seller resumes the normal trading mode after the aggressive prices that caused activation of the trading control facility 204 have lessened. For example, if the target prices are $9.02 to $9.18 within an NBBO of $9.00-$9.20, with a NBBO mid-point of $9.10, and the buyer's trigger price was set at $9.18 and the reverse trigger was set at $9.15, the system would resume the normal trading mode sooner than it would if the reverse trigger price was set at the NBBO mid-point price of $9.10.

Further, the hysteresis between the trigger price and reverse trigger price may be set in view of trading environment. For example, if the price of a security is very volatile, the buyer or seller may select a larger hysteresis. There also may be other reasons for increasing or decreasing the hysteresis, such as managing trading risk, that are understood to be still within the scope of the present invention.

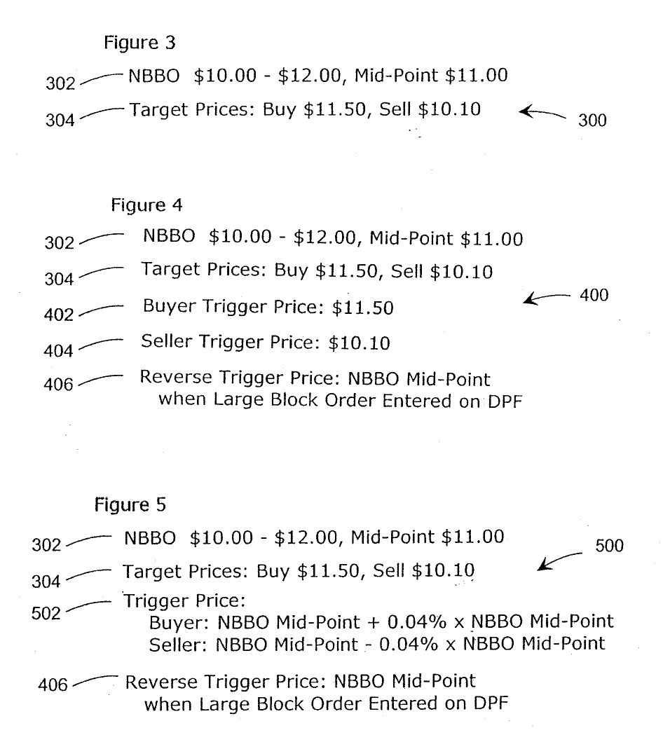

Referring to FIGS. 3-6, the present invention will be described in greater detail. Referring to FIG. 3, generally at 300, exemplary NBBO information and target price instructions are provided for describing the system and method of the present invention. More specifically, an exemplary NBBO and NBBO mid-point are shown at 302. In FIG. 3, the NBBO is shown as $10.00-$12.00, and given this NBBO, the NBBO mid-point is $11.00. At 304, exemplary target price instructions within the NBBO are shown for buying and selling securities. The buy target price is $11.50 and the sell target price is $10.10. Given this information, if the transaction price of a security of interest is within the target price instructions of the trader, then, typically, trading transactions can be automatically and anonymously effected at an agreed-upon trading price, such as the NBBO mid-point. However, it is understood that the agreed-upon trading price may be other than the NBBO mid-point and still be within the scope of the present invention. Therefore, if a large block institutional trader at 102 has provided the target price instructions at 304 in FIG. 3, and seeks to trade 50,000 shares of a particular security (as a buyer or seller) and places an order onto dark pool facility 108 for trading either direct or indirectly through a broker/dealer, the security will trade according to the trading parameters of algo programming 116 automatically and anonymously at the agreed-upon price with one or more trading counterparties as long as the transaction price of the security remains within the target price instructions. This is the normal trading mode of algo programming 116.

The normal trading mode just described was with regard to the use of algo programming 116. However, it is understood that other types of computer-based programmed trading other than algorithmic trading for auto-trading securities may be used and still be within the scope of the present invention whether or not such auto-trading is anonymous.

Referring to FIG. 4, generally at 400, the NBBO and target price instructions of FIG. 3 are shown, along with a dollar value trigger price and reverse trigger price for activating and deactivating trading control facility 204 (FIG. 2), respectively. Specifically, the trigger and reverse trigger prices are provided as part of the trading instructions. More specifically, in FIG. 4, the NBBO and NBBO mid-point are shown at 302, the target price instructions are shown at 304, the dollar value buyer trigger price is shown at 402, the dollar value seller trigger price is shown at 404, and the reverse trigger price is shown at 406.

The buyer dollar value trigger price at 402 is shown as $11.50. Accordingly, if the transaction price of a security of interest is within the target price instructions at 304, then crossing counterparty orders will be auto-matched and normal trading will take place at the agreed-upon trading price. However, if the trader is a buyer and the transaction price for the security become more aggressive such that it passes through the buyer trigger price of $11.50, trading control facility 204 will be activated to control the quantity of shares traded within a predetermined time period.

The seller dollar value trigger price at 404 is shown as $10.10. If the trader is a seller, normal trading will occur until such time as the transaction price for the security becomes more aggressive such that it passes through the seller trigger price of $10.10. At this time, trading control facility 204 will be activated to control the quantity of shares traded on behalf of the seller within a predetermined time period.

Again referring to FIG. 4, the reverse trigger price is shown at 406. This is the price at which the normal trading mode will be resumed. Preferably, the reverse trigger price will be the NBBO mid-point at the time the large block order was entered onto dark pool facility 108. According to FIG. 4, the reverse trigger price for either a buyer or seller is the NBBO mid-point of $11.00, since this is the NBBO mid-point value at the time the large block order was entered onto the dark pool facility.

FIG. 5, generally at 500, shows second embodiment of the invention in which the buyer and seller trigger price is not a fixed dollar value but determined based on another value, which in this case is the NBBO mid-point. In FIG. 5, the NBBO and NBBO mid-point are shown at 302, the target price instructions are shown at 304, the trigger prices are shown at 502, and the reverse trigger price is shown at 406.

With regard to the trigger prices shown at 502, the buyer trigger price is the NBBO mid-point plus 4% of that price at the time the large block order was entered. Accordingly, the buyer trigger price given the NBBO and NBBO mid-point shown at 302 would be $11.44. With regard to the seller trigger price, it will be determined based on the NBBO mid-point minus 4% of that price at the time a large block order was entered. As such, the seller trigger price given the NBBO and NBBO mid-point shown at 302 would be $10.16.

The representative calculations of the buyer and seller trigger prices in FIG. 5 have been based on the NBBO mid-point price. However, it is understood that other prices could be used and still be within the scope of the present invention. Further, the representative calculation of the buyer and seller trigger prices was based on 4%. It is understood that other percentages may be used and still be within the scope of the present invention.

FIGS. 4 and 5 at 406 show the reverse trigger price as the NBBO mid-point price at the time the large block order was entered onto the dark pool facility. This specific reverse trigger price is only exemplary. Other reverse trigger prices may be used and still be within the scope of the present invention. Further, the reverse trigger price may not be a fixed dollar value but determined based on another value and still be within the scope of the present invention.

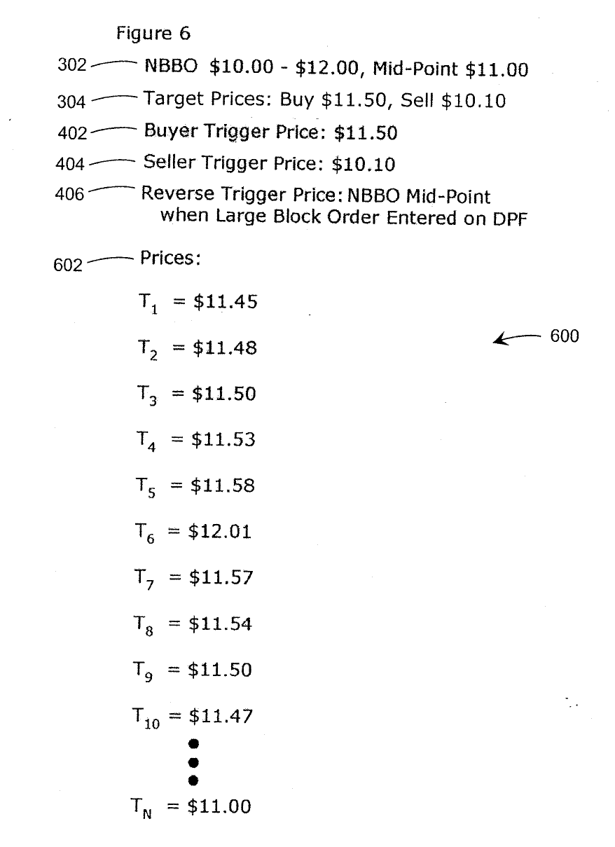

Referring to FIG. 6, generally at 600, a representative example of the operations of dark pool facility 108 (FIGS. 1 and 2) using trading control facility 204 will be described. Further, FIG. 6 will be described with regard to the activation and deactivation of the trading control facility from the perspective of a buyer.

For purposes of example only, a large block institutional trader directly or through a broker/dealer seeks to buy 100,000 shares of Security A in dark pool facility 108, and the trader has provided the target price instructions shown at 304. At the time the order is entered, the NBBO and NBBO mid-point are as shown at 302. The buyer trigger price and reverse trigger price are shown at 402 and 406, respectively. Further, the NBBO mid-point prices for time periods T₁ to T_{N} are shown at 602. By way of example only, each of the time periods shown at 602 is 30 seconds. For completeness of the target price instructions, the seller trigger price is shown at 404.

Again referring to FIG. 6, during times T₁ and T₂, the NBBO mid-point price is within the target price instructions so the normal trading mode will be active for filling the buy order with counterparties trading on dark pool facility 108 using algo programming 116, matching engine 112, and system database 114. At time T₃, the NBBO mid-point price becomes more aggressive and passes through the upper price limit, the trigger price. This will cause activation of trading control facility 204 (at FIG. 2) to control the buy transactions that will take place during 30 second time periods until the NBBO mid-point price becomes less aggressive and the reverse trigger price is crossed and trading control facility 204 is deactivated.

The maximum number of shares that may be traded during a given time period once trading control facility 204 is activated may be part of the instructions that are input to dark pool facility 108 by the trader or is a default condition of the dark pool facility. The time periods also are configurable and may be part of the trading instructions or is a default condition. By way of example, the instruction or default may be 3,000 shares per 30 second time period. Therefore, if during time periods T1 and T₂ the total trading volume of Security A was 55,000 shares, once trading control facility 204 is activated at time period T₃, only 3,000 shares could be traded during the succeeding 30 second time periods. As such, once the trading volume reaches 3,000 during time period T₃, trading control facility 204 will block any further trading of Security A. By way of example, if the trading volume reached 3,000 shares of Security A in the first 20 seconds of time period T₃, there will be no further trading of Security A until time period T₄.

If during time period T₃ the trading volume reached only 2,500 shares, in a preferred embodiment, the remaining 500 shares will not be added to the next time period T₄ such that during this next time period, the trading volume would be increased to 3,500 shares. As such, if trading control facility 204 is still activated at time period T₄, the maximum trading volume would still be 3,000 shares.

Again referring to FIG. 6 at 602, from time period T3 to T₈, the NBBO mid-point price remains aggressive and above the buyer reverse trigger price of $11.00; as such, the trading control facility will remain activated. At time period T₉, the NBBO mid-point price is continuing to be less aggressive and passes through the buyer trigger price; however, this will not deactivate trading controlled facility 204 because the current NBBO mid-point price has not become less aggressive to the point where it passes through the reverse trigger price. From time period T₁₀ to T_{N}, the current NBBO mid-point price becomes less aggressive and at time period T_{N} passes through the reverse trigger price, the NBBO mid-point price at the time the large block order was entered onto dark pool facility 108. If, at this point, the 100,000 share order has not been filled, the system will return to the normal trading mode for the buyer with respect to trading Security A.

The trader's instructions with respect to activation of trading control facility 204 areconfigurable such that it may apply to a single security, multiple securities, or all securities with respect to that trader. With respect to the time periods, they are configurable to apply on the entire trading day or portions of the trading day and still be within the scope of the present invention.

In a preferred embodiment, when the trading control facility is activated, if the number of shares traded for a security does not meet the maximum number in a given time period, there is no carryover of the excess shares to the next time period. However, it is understood that in a further embodiment of the present invention, there can be carried over of excess shares to the next time period as long as the average number of shares being traded over all time periods when trading control facility 204 is activated are at or below the maximum number for any given single time period.

It is understood that from the perspective of a seller, the description set forth with respect to FIG. 6 will also apply except that the seller trigger price will be used to activate trading control facility 204 when the current NBBO mid-point price passes through the sell target price, and the trading control facility will be deactivated when this price becomes less aggressive and passes through the NBBO mid-point price that was in effect at the time the large block sell order was entered onto dark pool facility 108.

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments or portions thereof, may also be implemented as a machine-readable storage medium, configured with a computer program, where, upon execution, instructions in the computer program cause a machine to operate to perform the functions of the embodiments described above.

The embodiments, or portions thereof, of the system and method of the present invention described above may be used in a variety of applications. Although the embodiments, or portions thereof, are not limited in this respect, the embodiments, or portions thereof, may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory.

The terms and expressions which are used herein are used as terms of expression and not a limitation. And, there is no intention, in the use of such terms and expressions, of excluding the equivalence of the features shown and described, or portions thereof, it being recognized that various modifications are possible in the scope of the invention.

1. A computer-implemented trading system for auto-trading securities when transaction pricing is within target prices and in a controlled manner when transaction pricing is outside of such target prices, comprising:
a plurality of electronic input and display devices for traders to input buy and sell orders and trading instructions, and receiving trading transaction information;
a dark pool facility for receiving buy and sell orders and trading instructions transmitted from the electronic input and display devices and matching crossing buy and sell orders, and transmitting trading transaction information to the plurality of electronic input and display devices, with the dark pool facility including at least,
a matching engine for matching crossing counterparty buy and sell orders,
a database for storing buy and sell orders for matching, and trading transaction information that includes at least order fulfillment information based on matches completed by the matching engine,
first programming means for controlling the matching engine and database to auto-match crossing counterparty buy and sell orders according to programming of the first programmable means and trading instructions of counterparty traders to a trading transaction input through respective electronic input and display devices,
second programming means for controlling the first programming means, matching engine, and database to auto-match crossing counterparty buy and sell orders under conditions when transaction pricing in matching crossing counterparty buy and sell orders according to the programming of the first programming means exceeds the buy or sell target price instructions input as part of the trading instructions by a buyer or seller, respectively, and
a communications interface for receiving buy and sell orders and trading instructions from the plurality of electronic input and display devices and transmitting trading transaction information to the plurality of electronic input and display devices; and
a communications link for transmitting buy and sell orders and trading instructions input by traders at the plurality of electronic input and display devices to the communications interface of the dark pool facility and transmitting trading transaction information from the communications interface to the plurality of electronic input and display devices.

2. The computer-implemented system as recited in claim 1, wherein each of the plurality of electronic input and display devices includes client server.

3. The computer-implemented system as recited in claim 2, wherein the client server includes a personal computer, workstation, or desktop computer with a display screen.

4. The computer-implemented system as recited in claim 1, wherein the dark pool facility includes a system server.

5. The computer-implemented system as recited in claim 4, wherein the system server includes a single computer or a distribution network of computers.

6. The computer-implemented system as recited in claim 1, wherein the first programming means includes order matching programming.

7. The computer-based system as recited in claim 6, wherein order matching programming includes algorithmic order matching programming.

8. The computer-implemented system as recited in claim 1, wherein the second programming means includes a trading control programming to control trading transactions by limiting the volume of trading transactions that can be completed in a predetermined fixed time period.

9. The computer-implemented system as recited in claim 1, wherein the communications link includes a wired or wireless communications link.

10. The computer-implemented system as recited in claim 1, wherein the system includes auto-trading large blocks of securities.

11. The computer-implemented system as recited in claim 1, wherein trading instructions include at least a buy target price, a trigger price to activate the second programming means, a reverse trigger price to deactivate the second programming means, and the trading volume per predetermined time period for the trader as a buyer, with the reverse trigger price having a value less than the trigger price.

12. The computer-implemented system as recited in claim 1, wherein trading instructions include at least a sell target price, a trigger price to activate the second programming means, a reverse trigger price to deactivate the second programming means, and the trading volume per predetermined time period for the trader as a seller, with the reverse trigger price having a value greater than the trigger price.

13. A computer-implemented method for auto-trading securities when transaction pricing is within target prices and in a controlled manner when transaction pricing is outside of such target prices, comprising the steps of:
(A) inputting a buy or sell order and trading instructions into a dark pool facility, with the trading instructions including at least a target price for buying or selling a security, a trigger price for a buyer or seller to activate trading control to control a trading volume of the security per a predetermined fixed time period, and a reverse trigger price for a buyer or seller to deactivate trading control, with the reverse trigger price having a value less than a buyer trigger price for buying the security and a value more than a seller trigger price for selling the security, and a trading volume per fixed predetermined time period by a trader as a buyer or seller;
(B) auto-matching crossing counterparty buy and sell orders in the dark pool facility according to a first operating mode when a transaction price is equal to, or less than, the buyer trigger price input by the buyer, or is equal to, or more than, the seller trigger price for the seller;
(C) transitioning from the first operating mode to a second operating mode for controlling auto-matching crossing counterparty buy and sell orders in the dark pool facility when a transaction price is more than the buyer trigger price input by the buyer or less than the seller trigger price for the seller, with the trading volume of the security being limited to a predetermined volume within each of one or more fixed time periods while the system is operating according to the second operating mode;
(D) transitioning from the first operating mode to the second operating mode when the transaction price is less than the reverse trigger price for a buyer or more than the reverse trigger price for a seller; and
(E) transmitting order fulfillment information to one or more buyers and one or more sellers for trading transactions completed by auto-matching at steps (B), (C), and (D).

14. The method as recited in claim 13, wherein the buyer reverse trigger price is less than the buyer trigger price.

15. The method as recited in claim 13, wherein the seller reverse trigger price is more than the seller trigger price.

16. The method as recited in claim 13, wherein the buyer trigger price or seller trigger price includes a fixed numeric value.

17. The method as recited in claim 13, wherein the buyer trigger price or seller trigger price includes a value calculated based on a fixed or floating value.

18. The method as recited in claim 13, wherein the buyer reverse trigger price or seller reverse trigger price includes a fixed numeric value.

19. The method as recited in claim 13, wherein the buyer reverse trigger price or seller reverse trigger price includes a value calculated based on a fixed or floating value.

20. The method as recited in claim 13, wherein the method includes auto-trading large blocks of securities.
